(19) United States
(12) Patent Application Publication
(10) Pub. No.: US 2009/0304760 A1
(43) Pub. Date: Dec. 10, 2009

(54) Biocidal Film-Forming Composition and Method for Coating Surfaces With It

(76) Inventors: Keith Seymour, Marseyside (GB); Brian John O'Hehir, Marseyside, NY (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/084,868

(22) PCT Filed: Nov. 10, 2006
(86) PCT No.: PCT/GB2006/050383

§ 371 Date: Jan. 27, 2009

(30) Foreign Application Priority Data
Nov. 10, 2005 (GB) 0522906.7

(51) Int. Cl. A01N 25/00; A01N 43/78

(52) U.S. Cl. 424/405; 514/369

(57) ABSTRACT

A biocidal film-forming composition comprising, a nitrogen-containing biocide, a sulphur-containing biocide, an oleophilic carrier, and a film-forming agent. The invention also includes a method of coating an item with that composition. The present invention provides for the manufacture of solid items from plastics materials in which the biocidal composition has been included.

### FIELD OF THE INVENTION

This invention relates to biocidal compositions, methods of manufacturing biocidal surfaces and biocidal articles.

### BACKGROUND TO THE INVENTION

For many buildings, rooms and work surfaces it is desired to impart an anti-microbial activity to floors and surfaces of such structures. For example, in clinical and hospital environments, it is desirable to impart anti-microbial effect to walls, floors, surfaces of hospital furniture such as cabinets and beds and to fixtures and fittings thereof, such as door handles and locks.

In many cases, imparting anti-microbial effects to these surfaces is necessary to prevent cross contamination of different surfaces, and to prevent patients and/or clinical staff from becoming contaminated with microbes through use of the surfaces and structures.

It is known to impart an anti-microbial effect, in the short term, by spraying liquid anti-microbial compositions onto a desired surface, which has the effect of removably depositing anti-microbial chemicals on the surface, thereby killing or preventing growth of any microbes on the surface, and preventing cross contamination when touched by a user.

However, using this method, there are many disadvantages. Firstly it is difficult to effect an accurate coverage of the surface using the techniques of spraying or painting liquid compositions, and therefore parts of any surfaces sprayed or painted may not be Imparted with sufficient anti-microbial activity. Secondly, as the liquid compositions simply spray on particulate anti-microbial composition, which is not bound to the surface, the antimicrobial composition is easily removed, and the anti-microbial effect is temporary, to the point that any contact with the surface may remove the anti-microbial composition and thereby remove the anti-microbial effect from the surface.

It would therefore advantageous to provide an antimicrobial composition which can be applied to surfaces and load bearing structures, and which is permanently applied to those surfaces and structures, such that contact by a user or another surface does not remove the anti-microbial composition. It would be further advantageous to provide an anti-microbial composition which is permanent when applied to a surface or load bearing structure, and in which the surface or load bearing structure may be washed or wiped without removal of the anti-microbial composition.

It is therefore an aim of preferred embodiments of the invention to overcome or mitigate at least one of the problems of the prior art, whether expressly disclosed herein or not.

### SUMMARY OF THE INVENTION

According to a first aspect of the present invention there is provided a biocidal film-forming composition comprising, a nitrogen-containing biocide, a sulphur-containing biocide, an oleophilic carrier, and a film-forming agent.

Suitably the oleophilic carrier comprises glycol and preferably a linear or branched C₂-C₁₂ dihydroxy alkane, more preferably a C₂-C₆ dihydroxy alkane. Preferably the glycol comprises a linear alkyl chain. Preferred glycols include ethylene glycol, propylene glycol, butylene glycol and hexalene glycol, with propylene glycol being particularly preferred.

Where the glycol comprises more than 3 carbon atoms in the alkyl chain the hydroxyl groups are preferably present on the 1 and 2 carbon atom positions. Thus preferred as glycols are 1,2-dihydroxyalkanes.

The film-forming agent is preferably a polymeric film-forming agent. Polymers suitably as polymeric film-forming agents include, polymers of and co-polymers of:
(1) acrylic esters and methacrylic esters having an aliphatic hydroxyl group such as 2-hydroxyethylmethacrylate or 2-hydroxyethylacrylate.
(2) alkylacrylates such as methyl acrylate, ethyl acrylate, propyl acrylate, butyl acrylate, amyl acrylate, hexyl acrylate, octyl acrylate, benzyl acrylate, 2-chloroethyl acrylate, glycidyl acrylate, and Ndimethylaminoethyl acrylate,
(3) alkylmethacrylates such as methyl methacrylate, ethyl methacrylate, propyl methacrylate, butyl methacrylate, amyl methacrylate, hexyl methacrylate, cyclohexyl methacrylate, glycidyl methacrylate, and N-dimethylaminoethyl methacrylate,
(4) acrylamides or methacrylamides such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, N-ethyl-N-phenylacrylamide,
(5) vinyl ethers such as ethylvinyl ether, 2-chloroethylvinyl ether, hydroxyethylvinyl ether, propylvinyl ether, butylvinyl ether, octylvinyl ether, and phenylvinyl ether,
(6) vinyl esters such as vinyl acetate, vinyl chloroacetate, vinyl butyrate, and vinyl benzoate,
(7) styrenes such as styrene, α-methylstyrene, methylstyrene, and chloromethylstyrene,
(8) vinyl ketones such as methylvinyl ketone, ethylvinyl ketone, propylvinyl ketone, and phenylvinyl ketone,
(9) olefins such as ethylene, propylene, isobutylene, butadiene, and isoprene,
(10) N-vinylpyrrolidone, N-vinylcarbozole, 4-vinylpyridine, acrylontrile, and methacrylonitrile,
(11) unsaturated Imides such as maleimide, N-acryloylacrylamide, N-acetylmethacrylamide, n-propionylmethacrylamide and n-(p-chlorobenzoyl) methacrylamide, and
(12) unsaturated carboxylic acids such as acrylic acid, methacrylic acid, maleic anhydride, and itaconic acid.

Particularly suitable polymeric film-forming agents include co-polymers of a vinyl ester, especially copolymers of vinyl acetate with a vinyl ester of a C₆-C₂₂ monocarboxylic acid.

The inclusion of an oleophilic carrier such as a glycol, glycerol, glyceride or glycol ester to compositions comprising biocidal agents and film-forming agents, enables efficient biocidal action throughout the resultant composition when coated on surfaces.

The nitrogen-containing biocide may be a non-oxidising or oxidising nitrogen-containing biocide.

The nitrogen-containing biocide may comprise an amide biocide, a triazine, a guanidine, a quaternary ammonium compound, a pryrethoid agent or mixtures or derivatives thereof, but is preferably a quaternary ammonium compound.

Suitably the quaternary ammonium compound comprises an optionally substituted linear or branched C₁-C₂₀ alkyl ammonium halide or alkylbenzylammonium halide. Preferably the alkylammonium halide is a dialkyldimethyl ammonium halide or an alkyldimethylbenzyl ammonium chloride.

The halide is preferably chloride, bromide or iodide, but is more preferably chloride.

Suitable quaternary ammonium compounds include dimethyl dibenzylammonium chloride, dodecyldimethyl ammonium chloride, ethylmethyl dibenzyl ammonium chloride and didecyl dimethyl ammonium chloride.

Suitably the nitrogen-containing biocide is present in the composition in an amount of at least 0.1 wt % of the total weight of the composition, preferably at least 1 wt %, more preferably at least 1.5 wt % and yet more preferably at least 2 wt %.

Suitably the nitrogen-containing biocide is present in the composition in an amount of no more than 10 wt %, preferably no more than 7.5 wt % and more preferably no more than 5 wt %, of the total weight of the composition.

The sulphur-containing biocide may be a non-oxidising or oxidising biocide.

Suitably the sulphur-containing biocide comprises a thiocarbonate, a thiocyanate, an isothiocyanate, a dithiocarbonate, a thiazole, a thiazolinone, an isothiazolinone, or any mixture or derivative thereof, but is preferably a thiazolinone or an isothiazolinone.

Suitable isothiazolinones include linear or branched C₁-C₆ alkylhalothiazolinones, or alkylhaloisothiazolinones.

Preferred isothiazolinones include methylisothiozolinones, especially 2-methyl-4-isothiazolin-3-one, and methylhaloiso thiazolinones, especially 5-chloro-2-methyl4-isothiazolin-3-one.

Suitably the sulphur-containing biocide is present in an amount of at least 0.001 wt % of the total weight of the composition, preferably at least 0.0025 wt %, and more preferably at least 0.005 wt %.

Suitably the sulphur-containing biocide is present in an amount of no more than 0.1 wt % of the total weight of the composition, preferably no more than 0.05 wt % and more preferably no more than 0.01 wt %.

The sulphur-containing biocide may also contain one or more nitrogen atoms, such as in the case of thiazoles and thiazolinones, and thus in some embodiments of the invention there may be a single biocide which comprises both a nitrogen atom and a sulphur atom but the biocidal composition of the invention preferably comprises both a nitrogen-containing biocide and a separate sulphur-containing biocide, whether or not the sulphur-containing biocide comprises nitrogen atoms or not.

The pryrethoid agent may be a pyrethroid or pyrethroid ether, for example. The pyrethroid agent may be natural or synthetic. Suitable pyrethroid agents include acrinathrin, allethrin, bathrin, cyclethrin, cypermethrin, permethrin, deltamethrin, bifenthrin, and cyfluthrin.

Suitably the pyrethroid agent is present in an amount of at least 0.01 wt % of the total weight of the composition, preferably at least 0.05% wt and more preferably at least 0 1% wt. Suitably the pyrethroid agent is present in an amount of no more than 6% wt of the total weight of the composition, preferably no more that 4 wt % and more preferably no more than 2.5 wt %.

Preferably the composition contains at least one nitrogen-containing biocide and at least one sulphur-containing biocide. Preferably the nitrogen-containing biocide and sulphur-containing biocide are separate biocides.

“Biocide” means an agent capable of killing or preventing growth of a micro-organism such as a bacteria, viruses, fungi, algae and the like; animals, especially insects such as mosquitoes, for example; and/or plants.

Particularly suitable biocides in compositions of the invention are effective at killing or preventing growth of bacteria, viruses, algae, fungi and/or, especially, insects.

The polymeric film-forming agent is suitably present in the composition in an amount of at least 20 wt % of the total weight of the composition, preferably at least 25 wt %, more preferably at least 30 wt % and most preferably at least 40 wt %.

Preferably the polymeric film-forming agent is present in an amount of no more than 80 wt % of the total weight of the composition, preferably no more than 70 wt %, and more preferably no more than 60 wt %.

Preferably the biocidal composition further comprises a solvent, and is thus preferably a liquid composition. Suitably the biocidal composition is an aqueous biocidal composition. Preferably the aqueous biocidal composition comprises water in an amount of at least 20 wt % of the total weight of the composition, more preferably at least 30 wt % and most preferably at least 40 wt %. Suitably the liquid biocidal composition comprises water in an amount of no more than 80 wt %, preferably no more than 70 wt % and more preferably no more than 60 wt %, of the total weight of the composition.

The biocidal film-forming composition may contain one or more further ingredients including a thickener, such as hydroxyethyl cellulose, a defoaming agent, ammonia, an alcohol such as 2-propanol and/or one or more inorganic salts such as, for example, magnesium salts.

The oleophilic carrier or an alcohol may act as a co-solvent when the biocidal composition is an aqueous composition, or may be the primary solvent where the liquid biocidal composition is a non-aqueous composition.

The film-forming biocidal composition may include a fragrance or perfume. The fragrance or perfume may comprise a synthetic fragrance or perfume, or a natural product.

The film-forming composition preferably further includes a UV-stabiliser that delays or prevents the light sensitive degradation of the biocidal activity of a film formed from the present invention. This advantageously ensures that the composition is not limited to use in places where there is no direct sunlight.

According to a second aspect of the invention there is provided a method of manufacturing a biocidal surface, the method comprising the step of:
(a) applying the composition of the first aspect of the invention to a surface.

Preferably the biocidal composition is a liquid composition comprising one or more solvents and the method comprises after step (a) a step (b) of drying the coating. Drying may comprise removing a portion of the or each solvent present, but preferably comprises removing substantially all of the or each solvent present, to form a solid coating. Thus, when the liquid biocidal composition is an aqueous composition, drying preferably comprises removing substantially all of the water present in the composition (which may exclude water in any hydrates present in the composition).

Drying may comprise evaporating the or each solvent. Evaporation may be effected by allowing gradual evaporation at ambient temperature, or by effecting heating of the surface and/or coating. Heating may be performed by any suitable means such as placing the coated surface in a heated oven, or effecting heated airflow in the region of the coated surface. Effecting heated airflow is preferred if the surface is bulky, or part of a large article such as a vehicle interior, or is a load bearing structure such as a wall for example.

The surface may be an absorbent surface, such as porous or fibrous surface for example, and step (a) may comprise applying a coating of the liquid composition of the invention to the absorbent surface such that at least a portion of the composition is absorbed by the surface. In some embodiments of the invention, the liquid composition may be of a viscosity such that it is not absorbed by an absorbent surface upon coating the surface.

The surface may be any suitable surface for which it is desired to impart a biocidal effect thereto. Examples of suitable surfaces include metal surfaces (including alloy), wood surfaces, plastics surfaces, textile surfaces, concrete surfaces, cement surfaces, glass surfaces, rubber surfaces, aggregates and any of the aforesaid surfaces when coated with paint.

Preferred surfaces include doors, walls, flooring, vehicle surfaces and surfaces of furniture such as tables, chairs, cabinets, surfaces of kitchen and bathroom furniture, surfaces of industrial and clinical equipment, and the like for example, or any surface to which it is desired to impart antimicrobial properties.

The method may, for example, comprise coating the liquid composition by spraying or dip-coating the surface with the liquid composition, by painting, brushing or rollering the composition onto the surface, or by any other suitable method.

The method may comprise mixing the composition with a carrier material, the carrier material being arranged to effect adhesion of the composition onto the surface. The carrier material may be, for example, a paint, lacquer or glaze. Thus, the composition may be mixed with a paint, and applied in a conventional manner to wallpaper on a surface(s) in a room in order to paint the wallpaper or walls, and impart biocidal properties to the wallpaper.

Suitably, when the biocidal composition is mixed with a carrier material; the ratio of the biocidal composition to carrier material is at least 1:99, preferably at least 5:95, and more preferably at least 8:92. Preferably, the ratio of biocidal composition to carrier material is no more 20:80, preferably no more than 15:85 and more preferably no more than 12:88.

Suitably the composition is coated on a surface such that the dry coating weight is at least 0.1 gm⁻², preferably at least 0.2 gm⁻² and more preferably at least 0.5 gm⁻². Suitably the composition is coated on a surface such that the dry coating weight is no more than 20 gm⁻², preferably no more than 10 gm⁻².

Suitably the composition is coated on the surface to a dry film thickness of at least 10 μm, more preferably at least 15 μm, and preferably to no more that 50 μm, more preferably no more than 35 μm, most preferably no more than 25 μm.

“Dry coating weight” means the weight of the coating in a substantially solid form, which may be after the or each solvent has been substantially removed by drying. Thus for an aqueous composition the dry coating weight is considered to be the weight of the coating when the water, and any co-solvents present, has or have been substantially removed.

Preferably the article is manufactured by the method of the second aspect of the invention.

The composition described herein may, as well as forming surface films, be incorporated into solid materials during manufacture. For example, during formation of plastics granules for a variety of downstream construction uses the composition may be incorporated. This imparts to the plastics and those items constructed therefrom, the biocidal activities like the coatings discussed already. This would allow the formation of items such as biocidal bags, boxes and pouches. The present invention could also be used to form biocidal filters for cleaning flowable material such as air and water.

### EXAMPLES

The following materials are used hereinafter:
N,N-Ndecyl-N-N-dimethylammionium chloride—supplied by Lonza, UK.
2-Propanol—supplied by Lonza, UK.
5-Chloro-2-methyl-4-isothiazolin-3-one—supplied by Lonza, UK.
2-Methyl-4-isothiazolin-3-one—supplied by Lonza, UK.
Magnesium salts (chloride and nitrate)—supplied by Lonza, UK.
Fragrance—a multi-component mixture of natural and synthetic aromatic materials consisting of amyl cinnamic aldehyde, citronellol, coumarin, diphenyl oxide, lavandin grosso, musk xylol and oak moss resin, supplied by Dale Air Limited, Lytham, UK.
Water—Deionised water.
Mastercryl T999118—a formulation comprising the following ingredients: water 45-50% w/v, hydroxyethylcellulose thickener 0.25-0.75% w/v, vinyl acetate copolymer emulsion (comprising vinyl acetate copolymerised with the vinyl ester of Versatic (RTM), a saturated monocarboxylic acid containing 10 carbon atoms) 45-50% w/v, defoamer 0.5-0.75% w/v, ammonia 0.02-0.04% w/v, hexalene glycol 1.5-2.5% w/v and ester gycol (2,2,4-trimethyl-1,3-pentanediol) 0.5-1.5% w/v. Mastercryl T999118 was supplied by Ameron Coatings, UK.

### Example 1

Two biocidal intermediate formulations, Formulation A and Formulation B were prepared as set out in Table 1 below:

TABLE 1

| | Formulation A | Formulation B |
|---|---|---|
| Ingredient | % w/w | % w/w |
| N,N-Didecyl-N-N- | 2.5 | 2.5 |
| dimethylammonium chloride | | |
| 2-propanol | 0.9 | 0.9 |
| 5-Chloro-2-methyl-4- | 0.005 | 0.005 |
| isothiazolin-3-one | | |
| 2-Methyl-4-isothiozolin-3-one | 0.001 | 0.001 |
| Magnesium chloride and | 0.112 | 0.112 |
| magnesium nitrate 50:50 | | |
| Water | 94.232 | 94.232 |
| Dipropylene glycol | 2.5 | 0 |
| Fragrance Composition | 0 | 2.5 |

Thus, the Fragrance Composition in Formulation B and the dipropylene glycol in Formulation A serve as the oleophilic carrier according to the invention. A Control Formulation was also prepared, in which the ingredients were identical to Formulation A and B, with the exception that dipropylene glycol, N,N-Didecyl-N-N-dimethylammonium chloride and each of the isothiazolinones were absent, such that the Control Formulation did not substantially include an oleophilic carrier or biocide of the invention.

In each of Formulations A and B, and the Control Formulation the ingredients were added to the water component of formulations, and thoroughly mixed. In the case of Formulations A and B, thorough mixing was achieved relatively rapidly, and no residual solids were noted. In the case of the Control Example, mixing was difficult, in the absence of an oleophilic carrier, and separation into some of the components was noticed.

The biocidal intermediate compositions were then mixed with Mastercryl T999118 in a ratio of 10% w/v to intermediate 90% w/v Mastercryl, giving film forming biocidal compositions of the invention, hereinafter referred to as “Formulation A^{F}” and “Formulation B^{F}”

Formulations A^{F} and B^{F} were then coated onto plastics surfaces (in a controlled rendered environment). The formulations were coated such that upon evaporation, of the water component at ambient temperatures, the solid coating weight of the remaining coating was a minimum of 1 gm⁻².

The surfaces were then tested at weekly intervals to determine microbial presence on the surfaces.

A Control Formulation was prepared by mixing the biocidal intermediate composition of formulation B described above with propan-2-ol in a ratio of 10% w/v to 90% w/v intermediate composition to propanol. Again, the Control Formulation was coated onto a surface and the propan-2-ol evaporated at ambient temperature to leave a dry coating weight of approximately 1 gm⁻² on the surface. The Control Formulation did not include the polymeric film-forming agent of the Mastercryl Composition.

After testing for microbial activity on a weekly basis, the results showed that the film forming biocidal composition of Formulation A provided good anti-microbial activity such that no substantial build up on microbes was present on the surface after approximately 2 years, but that the Control Formulation showed inferior biocidal activities such that significant numbers microbes were present on the surface after just a few hours.

Thus the results show that the solid film coating of the present invention effected enhanced anti-microbial activity on the surface, compared to the Control Formulation, which did not form a solid film on the surface, but simply deposited particulate solid biocide.

It was also found that decreasing the ratio of the intermediate composition to film-forming agent, to as low as 5%:95%, resulted in substantially the same biocidal effectiveness.

### Example 2

Formulation B^{F} was mixed with a commercially available blue paint (Blue Base, Matt Wipe Clean Paint, supplied by ICI Paints, UK) in a ratio of 10% Formulation B^{F} to 90% paint. The resultant paint formulation was coated onto wallpaper and the wallpaper folded into a container having one open end, and left to dry. The dried container was then placed over a captured housefly, and the container left for 15 minutes. After 15 minutes the container was removed and it was observed that the fly was dead. The experiment was repeated using other formulations, corresponding to Formulation B^{F}, but in which the intermediate composition was present in amounts of 8, 6, 4, 2 and 1% w/v in Mastercryl. Paint formulations were prepared as described above by mixing the formulations with blue paint. Each of the resultant paint formulations was coated onto wallpaper and a container made up as described above. Flies were then trapped within the container and left for 15 minutes. The results showed that in each case, the fly was dead within 15 minutes of entrapment in the container. The results show that the biocidal film forming composition of the invention effects quick insecticidal action at low concentrations when mixed with commercial paint and coated onto wallpaper, as would commonly be undertaken in a domestic or industrial decorating situation.

The above experiments from Example 2 were repeated, but with ants trapped within the resultant containers, and again the results showed that within 6 to 8 minutes of entrapment, for all paint formulations, the ants were dead.

In other examples the dimethylammonium chloride biocidal component of the biocidal compositions of Examples 1 and 2 was replaced with an insecticidal pyrethroid in identical amounts, such as cypermethrin, cyclomethrin and acrinathrin. Excellent biocidal results against insects were obtained using such compositions.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A biocidal film-forming composition comprising a nitrogen-containing biocide, a sulphur-containing biocide, an oleophilic carrier, and a film-forming agent.

2. A biocidal film-forming composition as claimed in claim 1 wherein the nitrogen-containing biocide comprises an amide biocide, a triazine, a guanidine, a quaternary ammonium compound, or mixtures or derivatives thereof.

3. A biocidal film-forming composition as claimed in claim 1 wherein the nitrogen-containing biocide comprises an optionally substituted linear or branched C₁-C₂₀ alkyl ammonium halide or alkylbenzylammonium halide.

4. A biocidal film-forming composition as claimed in claim 3 wherein the alkylammonium halide is a dialkyldimethyl ammonium halide or an alkyldimethylbenzyl ammonium chloride.

5. A biocidal film-forming composition as claimed in claim 1 wherein the nitrogen-containing biocide is present in the composition in an amount of at least 1 wt % of the total weight of the composition.

6. A biocidal film-forming composition as claimed in claim 1 wherein the nitrogen-containing biocide is present in the composition in an amount of no more than 10 wt % of the total weight of the composition.

7. A biocidal film-forming composition as claimed in claim 1 wherein the sulphur-containing biocide comprises a thiocarbonate, a thiocyanate, an isothiocyanate, a dithiocarbonate, a thiazole, a thiazolinone, an isothiazolinone, or any mixture or derivative thereof.

8. A biocidal film-forming composition as claimed in 1 wherein the sulphur-containing biocide comprises methylisothiozolinones and methylhaloisothiazolinones.

9. A biocidal film-forming composition as claimed in claim 1 wherein the sulphur-containing biocide is present in an amount of at least 0.001 wt % of the total weight of the composition.

10. A biocidal film-forming composition as claimed in claim 1 wherein the sulphur-containing biocide is present in an amount of no more than 0.1 wt % of the total weight of the composition.

11. A biocidal film-forming composition as claimed in claim 1 which comprises at least 70 wt % water, based on the total weight of the composition.

12. A biocidal film-forming composition as claimed in claim 1 wherein the oleophilic carrier comprises an oleophilic solvent selected from the group consisting of an oleophilic glycol, a C₁-C₈ linear or branched alkylene glycol and dialkylene glycol.

13. A biocidal film-forming composition as claimed in claim 1, wherein the oleophilic carrier comprises one or more natural or synthetic compounds selected from the group consisting of aromatic aldehydes and ketones, amyl cinn antic aldehyde, plant oils, lavender oil, patchouli oil, peppermint oil, citrus oil, aromatic alcohols, citronellol and xyllols.

14. A biocidal film-forming composition as claimed in claim 1, wherein the oleophilic carrier comprises a mixture of natural oils, scents or fragrances.

15. A biocidal film-forming composition as claimed in claim 1 wherein the oleophilic carrier is present in the composition in an amount of at least 1 wt % of the total weight of the composition.

16. A biocidal film-forming composition as claimed in claim 1 wherein the oleophilic carrier is present in the composition in an amount of no more than 8 wt % of the total weight of the composition.

17. A biocidal film-forming composition as claimed in claim 1 wherein the film-forming agent is a polymeric film-forming agent.

18. A biocidal film-forming composition as claimed in claim 17, wherein the polymeric film-forming agent is a co-polymer of a vinyl ester.

19. A biocidal film-forming composition as claimed in claim 1, wherein a pyrethroid agent is present as, or in addition to, the nitrogen-containing biocide.

20. A biocidal film-forming composition as claimed in claim 19, wherein the pyrethroid agent is present in an amount in the range of 0.01% wt to 6% wt of the total weight of the composition

21. A biocidal film-forming composition as claimed in claim 1, wherein the film-forming agent is present in the composition in an amount of at least 20 wt % of the total weight of the composition.

22. A biocidal film-forming composition as claimed in claim 1, further comprising a solvent.

23. A biocidal film-forming composition as claimed in claim 22, wherein the biocidal composition is an aqueous biocidal composition.

24. A biocidal film-forming composition as claimed in claim 23, wherein the aqueous biocidal composition comprises water in an amount of at least 20 wt % of the total weight of the composition.

25. A biocidal film-forming composition as claimed in claim 1, comprising an organic solvent.

26. A biocidal film-forming composition as claimed in claim 25, wherein the organic solvent is an alkanol.

27. A method of manufacturing a biocidal surface, the method comprising the step of:
(a) applying the composition of claim 1 to a surface.

28. A method as claimed in claim 27, wherein the biocidal composition is a liquid composition comprising one or more solvents and the method comprises after step (a) a step (b) of drying the composition to form a coating.

29 A method as claimed in claim 27 wherein the surface is a metal surface, wood surface, plastic surface, textile surface, concrete surface, cement surface, glass surface, rubber surface, aggregate, or any of the aforesaid surfaces when coated with a covering.

30. A method as claimed in claim 27, wherein the surface is a door, wall, floor, vehicle surface, surface of an item of furniture, surface of an industrial apparatus or clinical apparatus.

31. A method as claimed in claim 27, wherein the method comprises mixing the composition with a carrier material, the carrier material being arranged to effect adhesion of the composition onto the surface.

32. A method as claimed in claim 0, wherein the carrier material is selected from the group consisting of a paint, a lacquer and a glaze.

33. A method as claimed in claim 0, wherein the ratio of the biocidal composition to carrier material, is between 1:99 and 12:88.

34. A biocidal article comprising a surface carrying a coating of the biocidal composition as claimed in claim 1.
